(19) United States
(12) Patent Application Publication
(10) Pub. No.: US 2026/0044431 A1
(43) Pub. Date: Feb. 12, 2026

(54) METHOD AND APPARATUS FOR VERIFYING USE OF OPEN SOURCE SOFTWARE

(71) Applicant: ELECTRONICS AND TELECOMMUNICATIONS RESEARCH INSTITUTE, Daejeon (KR)

(72) Inventors: Sang Su Lee, Daejeon (KR); Seung Kwang Lee, Yongin-si (KR); Dae Won Kim, Daejeon (KR); Yong Je Choi, Daejeon (KR); Dong Ho Kang, Daejeon (KR); Jeong Nyeo Kim, Daejeon (KR)

(73) Assignee: ELECTRONICS AND TELECOMMUNICATIONS RESEARCH INSTITUTE, Daejeon (KR)

(21) Appl. No.: 19/092,487

(22) Filed: Mar. 27, 2025

(30) Foreign Application Priority Data
Aug. 7, 2024 (KR) 10-2024-0105627

(51) Int. Cl. G06F 11/3604

(52) U.S. Cl. CPC G06F 11/3608

(57) ABSTRACT

Provided are a dynamic analysis method and an apparatus for verifying use of open source software, in which a computer-implemented method for verifying whether open source software is used includes inputting input data from a fuzzer to one or more software modules, collecting data sets generated during a process in which the software module processes the input data, vectorizing the collected data sets, measuring a similarity between the vectorized data sets, and generating a verification result based on the similarity.

### CROSS-REFERENCE TO RELATED APPLICATION

This application claims priority to Korean Patent Application No. 10-2024-0105627, filed on Aug. 7, 2024 in the Korea Intellectual Property Office, the entire contents of which are incorporated herein by reference.

### TECHNICAL FIELD

The present disclosure relates to a method and an apparatus for verifying use of open source software.

### BACKGROUND

The statements in this section merely provide background information related to the present disclosure and do not necessarily constitute prior art.

One software product generally utilizes other software as a small unitary component suitable for accomplishing the specific functions of that product. The most representative way to implement each component is to apply the same in the form of a library using an open source. However, the open source, due to its characteristics, is likely to be a main target for cyberattacks through vulnerability analysis. Thus, when a library or a product constituting particular software is based on other open source software, the safety of the open source may be a major factor that determines the security of the entire software using the same.

Recently, as the importance of systematic management of the use of open source for security of software supply chain has been highlighted, interest in software bill of materials (SBOM) is increasing. When a vulnerability is found from particular open source, the use of the open source may be verified through the SBOM and measures, such as safe patching and application, may be taken to prevent the propagation of problems caused by the vulnerability at an early stage.

The SBOM typically provides a hash digest value for managing a list of components, such as target open source or a library. However, problems may arise in accurately identifying components of large-scale software when creating the SBOM. Particularly, when reusing or modifying part of open source code, it is difficult to accurately identify the components.

When part or all of the open source code with the vulnerability is modified and then copied, it may be a factor that interferes with a normal verification function of the SBOM. This is because even when the open source code is partially loaded or modified and then integrated, detailed information, such as a version and a hash of the open source code, may be omitted from the SBOM or a hash value of the original open source code may be loaded into the SBOM. This may prevent efficient dependency management of the SBOM and thus result in propagation of code with the vulnerability.

Therefore, to widely ensure the purpose of security and software management by using the SBOM, it is necessary to provide a method for efficiently verifying the safety of software including open source code for which an accurate version is not provided.

A typical conventional method includes static analysis of binaries. More specifically, a reference binary whose vulnerability or safety is already known and a target binary to be analyzed are decompiled to determine the similarity therebetween in code structure. Based on the determination result, the library is identified and the vulnerability is determined. However, this method requires a lot of time and cost.

### SUMMARY

The following summary presents a simplified summary of certain features. The summary is not an extensive overview and is not intended to identify key or critical elements.

An aspect of the present disclosure is to provide a method and an apparatus for verifying use of open source software.

The aspects of the present disclosure are not limited to those mentioned above, and other aspects not mentioned herein will be clearly understood by those skilled in the art from the following description.

An object of the present disclosure is to provide a method for a user to verify whether particular open source is included in target software probabilistically through dynamic analysis technology using a dynamic binary instrumentation (DBI) tool when the user does not trust hash information of the open source included in software bill of materials (SBOM) due to suspicion of use of the open source or does not know the use of the open source as the SBOM is not provided, after the open source code is changed when the target software is developed.

The problems to be solved by the present invention are not limited to the above-mentioned problems, and other problems that are not mentioned will be clearly understood by those skilled in the art from the following description.

According to an aspect of the present disclosure, there is provided a computer-implemented method for verifying use of open source software. the computer-implemented method includes inputting input data from a fuzzer into one or more software modules, collecting, by the one or more software modules, data sets generated during a process of processing the input data, vectorizing the collected data sets, measuring a similarity between the vectorized data sets, and generating a verification result based on the similarity.

According to another aspect of the present disclosure, there is provided an apparatus including at least one memory, and at least one processor, wherein the at least one processor execute instructions for inputting input data from a fuzzer into one or more software modules, collecting, by the software modules, data sets generated during a process of processing the input data, vectorizing the collected data sets, measuring a similarity between the vectorized data sets, and generating a verification result based on the similarity.

According to an embodiment of the present disclosure, by performing dynamic analysis, it is possible to probabilistically determine the existence of a library or an open source-based component included in analysis target software by using instruction code and read and write information collected while processing arbitrary input data.

The effects of the present disclosure are not limited to the above-mentioned effects, and other effects that are not mentioned will be clearly understood by those skilled in the art from the following description.

These and other features and advantages are described in greater detail below.

### BRIEF DESCRIPTION OF THE DRAWINGS

FIG. 1 is a schematic block diagram of an apparatus for verifying use of particular open source software, according to an embodiment of the present disclosure.

FIG. 2 is a block diagram illustrating operations of an analyzer receiving input data from a fuzzer, collecting data, and measuring similarity, according to an embodiment of the present disclosure.

FIG. 3A is a diagram comparing the similarity between two-dimensionally converted matrices when a wildcard character X is I.

FIG. 3B is a diagram comparing the similarity between two-dimensionally converted matrices when the wildcard character X is R.

FIG. 3C is a diagram comparing the similarity between two-dimensionally converted matrices when the wildcard character X is W.

FIG. 4 is a diagram illustrating a process of collecting write (UW, PW, NW) information generated in a designated section of each of U, P, and N processes with respect to arbitrary input data (input1) generated from a fuzzer, according to an embodiment of the present disclosure.

FIG. 5 is a diagram illustrating the similarity measurement results between PX, UX, and NX using a similarity measurement algorithm.

FIG. 6 is a flowchart of a process of verifying existence of particular open source, according to an embodiment of the present disclosure.

FIG. 7 is a schematic block diagram of a computing device which can be used to implement the computer-implemented method or the apparatus according to the present disclosure.

### DETAILED DESCRIPTION

Hereinafter, one or more example embodiments of the present disclosure will be described in detail with reference to drawings. Note that when components in each drawing are denoted by reference numerals, the same components are denoted by the same reference numerals as much as possible even in different drawings. In addition, in describing the present disclosure, if it is determined that the detailed description of related known configurations or functions may obscure the gist of the present disclosure, the detailed description thereof will be omitted.

In describing components of embodiments according to the present disclosure, reference numerals, such as first, second, i), ii), a), and b), may be used. These reference numerals are only used to distinguish the components from other components, and the nature, sequence, order, or the like of the components is not limited by the reference numerals. In the specification, when a part “includes” or “comprises” an element, unless explicitly stated otherwise, the part may further include other elements rather than excluding the other elements.

The detailed description set forth below together with the appended drawings is intended to describe embodiments of the present disclosure and is not intended to represent the only embodiments of the present disclosure.

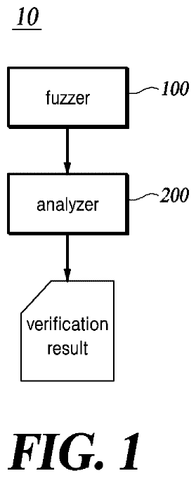

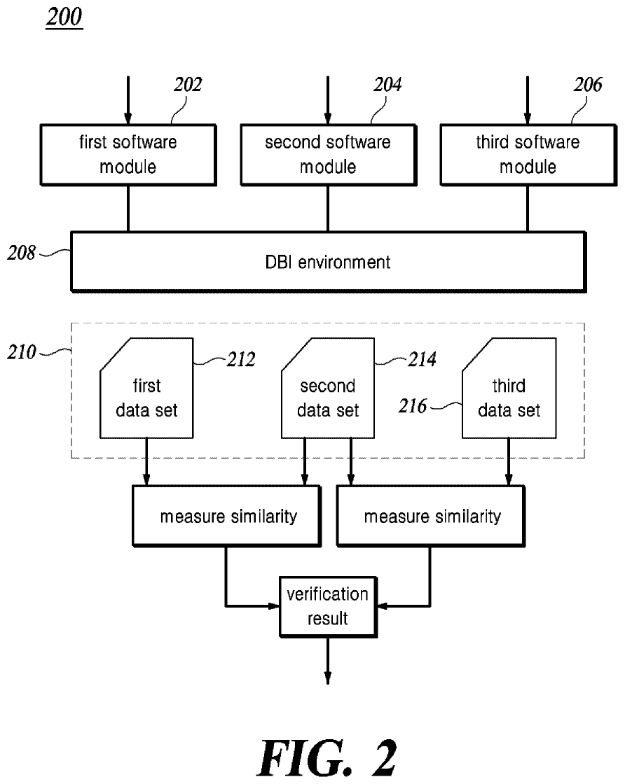

FIG. 1 is a schematic block diagram of an apparatus 10 for verifying use of particular open source software, according to an embodiment of the present disclosure. Reference may be made to FIG. 2 to illustrate FIG. 1.

The apparatus 10 for verifying use of open source software (hereinafter referred to as an “apparatus for verifying use of open source”), according to an embodiment of the present disclosure, may include at least one of a fuzzer 100 and an analyzer 200. The components shown in FIG. 1 are representative of functionally distinct elements. The components in FIG. 1 may be implemented in a form where at least one component is integrated with another in an actual physical environment.

The fuzzer 100 is a tool that randomly generates or converts input data of software to search various paths of a program and find potential bugs or vulnerabilities. The fuzzer 100 inputs input data to one or more software modules. The fuzzer 100 measures code coverage during software execution and detects exceptions or crashes. The fuzzer 100 records how the software reacts during this process.

The analyzer 200 receives various input data from the fuzzer 100 and collects a data set 210. The analyzer 200 converts each of the collected data sets into a two-dimensional matrix, and measures similarity or distance therebetween based on the converted two-dimensional matrix. The analyzer 200 generates a verification result based on the similarity between data vectorized into the two-dimensional matrix. Therefore, the analyzer 200 may probabilistically determine the existence of a library or an open source-based component included in the analysis target software.

FIG. 2 is a block diagram illustrating operations of the analyzer 200 receiving input data from the fuzzer 100, collecting data, and measuring similarity between the data, according to an embodiment of the present disclosure. Reference may be made to FIG. 1 to illustrate this process.

A first software module 202, a second software module 204 and a third software module 206 receive various input data from the fuzzer 100.

The first software module 202 is any software that uses particular open source software to be verified. That is, as a patched module, the first software module 202 is defined as “P”.

The second software module 204 is target software for verifying whether a particular version of open source software is used. That is, as an unknown module, the second software module 204 is defined as “U”.

The third software module 206 is any software that does not use a particular version of open source software to be verified. That is, as a non-patched module, the third software module 206 is defined as “N”.

The DBI environment 208 is an environment that uses tools to analyze binary code in real-time while the program is running, and to dynamically change the code as needed. The DBI environment 208 is used for software debugging, performance analysis, security analysis, and the like.

For the DBI environment 208, Intel PIN, Valgrind, or the like may be applied.

The apparatus 10 for verifying use of open source generates input data to each of the software modules 202, 204, and 206 including P, U, and N by using the fuzzer 100.

The software modules 202, 204, and 206 and the DBI environment 208 may be executed simultaneously.

The DBI environment 208 collects a data set 210 generated while each of the software modules 202, 204, and 206 processes the input data. The data set 210 includes a first data set 212, a second data set 214, and a third data set 216. The first data set 212 corresponds to PI, PR, and PW. PI is an instruction code set for P, PR is a memory read set for P, and PW is a memory write set for P. The second data set 214 corresponds to UI, UR, and UW. UI is an instruction code set for U, UR is a memory read set for U, and UW is a memory write set for U. The third data set 216 corresponds to NI, NR, and NW. NI is an instruction code set for N, NR is a memory read set for N, and NW is a memory write set for N. X is a wildcard character to indicate any one of I, R, and W.

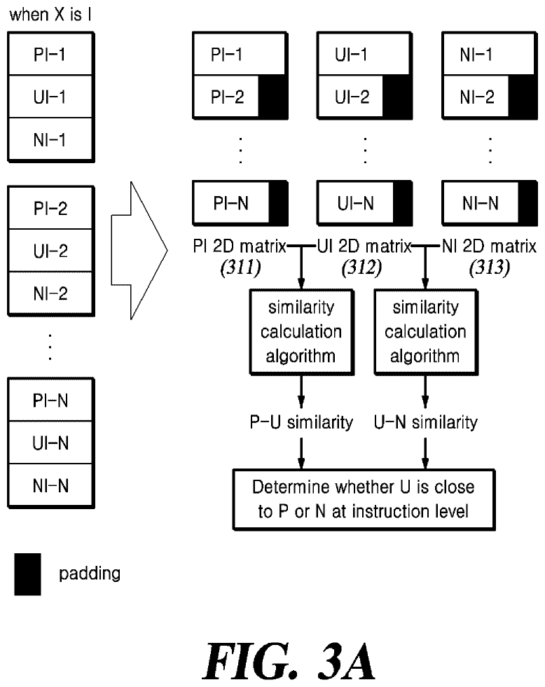

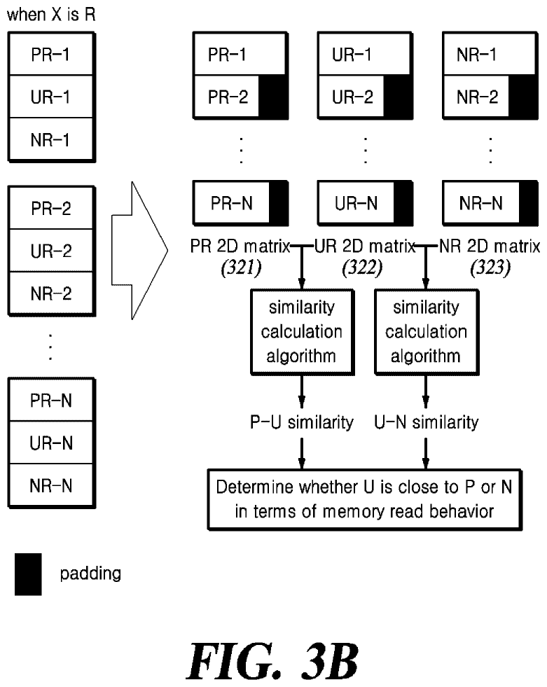

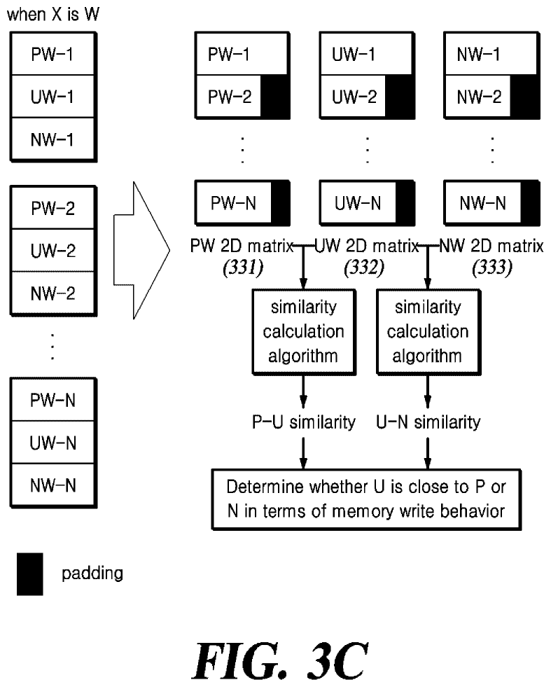

FIG. 3A is a diagram comparing the similarity between two-dimensionally converted matrices when a wildcard character X is I. Reference may be made to FIGS. 1 and 2 to illustrate FIG. 3A.

The data sets PI, UI, and NI collected from P 202, U 204, and N 206 are each converted into a two-dimensional matrix. In other words, the analyzer 200 may generate first to third matrices 311, 312, and 313 by vectorizing the data sets PI, UI, and NI collected by the DBI environment 208, respectively. The n^{th} row of the first to third matrices 311, 312, and 313 may include data sets PI-n, UI-n, and NI-n collected for the n^{th} input data. Since the numbers of input data input from the fuzzer 100 to P 202, U 204, and N 206 are the same, the numbers of rows of the first to third matrices 311, 312, and 313 are the same. However, the number of bytes in a column constituting a row may be different because an instruction code pattern executed for each piece of input data is different. To make the sizes of the first to third matrices 311, 312, and 313 the same, padding may be performed on the remaining rows based on the row having the longest column. Using an algorithm, the analyzer 200 measures the similarity between two-dimensionally converted matrices.

Specifically, referring to FIG. 3A, when the wildcard character X is I, data PI-1 to PI-n of P, data UI-1 to UI-n of U, and data NI-1 to NI-n of N are each combined to form one two-dimensional matrix 311, 312, and 313, respectively. The bit length of the data collected for each input may be different.

For example, if the length of data PI-1 for the first input for I of P is 100 bits and the length of data PI-2 for the second input for I of P is 80 bits, the remaining 20 bits are padded with 0. As such, a plurality of pieces of data for a plurality of inputs are arranged in accordance with the same bit length and converted into two-dimensional matrices 311, 312, and 313. The converted two-dimensional matrices are used to measure the similarity between P and U and the similarity between U and N, using a similarity measurement algorithm. For example, when the similarity using an algorithm is used, the similarity between PI and UI and the similarity between NI and UI are measured. That is, the similarity between PI and UW or between PI and UR may not be measured.

FIG. 3B is a diagram comparing the similarity between two-dimensionally converted matrices when the wildcard character X is R.

FIG. 3B may operate in the same or similar manner as described above with reference to FIG. 3A, even when the wildcard character X is R.

When the wildcard character X is R, data PR-1 to PR-n for R of P, data UR-1 to UR-n for R of U, and data NR-1 to NR-n for R of N are each combined to form one two-dimensional matrix 321, 322, and 323, respectively. The bit length of the data collected for each input may be different.

For example, if the length of data PR-1 for the first input for R of P is 100 bits and the length of data PR-2 for the second input for R of P is 70 bits, the remaining 30 bits are padded with 0. As such, a plurality of pieces of data for a plurality of inputs are arranged in accordance with the same bit length and converted into two-dimensional matrices 321, 322, and 323. The converted two-dimensional matrices are used to measure the similarity between P and U and the similarity between U and N, using a similarity measurement algorithm. For example, when the similarity measurement algorithm is used, the similarity between PR and UR and the similarity between NR and UR are measured. That is, the similarity between PR and UI or between PR and UW may not be measured.

FIG. 3C is a diagram comparing the similarity between two-dimensionally converted matrices when the wildcard character X is W. Reference may be made to FIG. 2 to illustrate FIG. 3C.

FIG. 3C may operate in the same or similar manner as described above with reference to FIG. 3A, even when the wildcard character X is W.

When the wildcard character X is W, data PW-1 to PW-n for W of P, data UW-1 to UW-n for W of U, and data NW-1 to NW-n for W of N are each combined to form one two-dimensional matrix 331, 332, and 333, respectively. The bit length of the data collected for each input may be different.

For example, if the length of data PW-1 for the first input for W of P is 100 bits and the length of data PW-2 for the second input for W of P is 60 bits, the remaining 40 bits are padded with 0. As such, a plurality of pieces of data for a plurality of inputs are arranged in accordance with the same bit length and converted into two-dimensional matrices 331, 332, and 333. The converted two-dimensional matrices are used to measure the similarity between P and U and the similarity between U and N, using a similarity measurement algorithm. For example, when the similarity measurement algorithm is used, the similarity between PW and UW, and the similarity between NW and UW are measured. That is, the similarity between PW and UI or between PW and UR may not be measured.

The user may select an algorithm used for the similarity measurement. The similarity measurement algorithm may include a Pearson correlation coefficient, a normalized compression distance, or a pattern matching. The present disclosure measures the similarity or distance between UX and PX, and between UX and NX, for example, using the Pearson correlation coefficient. The criterion for measuring the similarity may be information collected by a DBI tool in a function unit with a RET instruction as a boundary. That is, the criterion refers to memory read and write information, and instructions collected by function unit at each start and end during the program execution based on the RET instruction.

A target for measuring similarity may be y-axis data that can be extracted from a point on the x-axis in two-dimensional matrices of UX, PX, and NX collected in the DBI environment for all input data. Specifically, data collected at a particular time for all input data may be converted into a vector to measure mutual similarity, thereby moving the time axis. Alternatively, the similarity between UX, PX, and NX whose boundaries are divided by function unit may be measured for one input, and then the similarity result values for all the inputs may be accumulated.

Specifically, a process of measuring similarity between data sets vectorized into two-dimensional matrices is as follows: measuring a first similarity which is a similarity between the first data set 212 for the first software module 202 and the second data set 214 for the second software module 204; and measuring a second similarity which is a similarity between the second data set 214 for the second software module 204 and the third data set 216 for the third software module 206.

If the similarity measurement results show that UX is closer to NX than PX, it is determined that there is a high probability that a vulnerability exists. That is, if NX is highly similar to UX, it is determined that the corresponding open source is not used for U. Conversely, if PX is highly similar to UX, it is determined that the corresponding open source is used for U. In other words, if UX is measured to be similar to NX from instructions, and read and write data, it is determined that there is a high probability that the vulnerability exists. That is, it is classified as a dangerous level. When UX is measured to be similar to NX from any one or two of the instructions, and read and write data, it is classified as a level of questionable safety. When UX is measured to be similar to PX from the instructions, and read and write data, it is classified as a safe level.

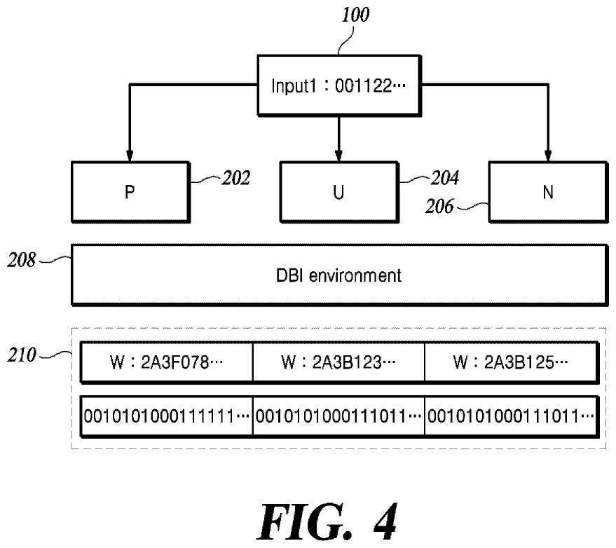

FIG. 4 is a diagram illustrating a process of collecting write (UW, PW, NW) information generated in a designated section of each of U, P, and N processes with respect to arbitrary input data (input1) generated from the fuzzer 100, according to an embodiment of the present disclosure.

Specifically, for each of P 202, U 204, and N 206, write information collected using the DBI environment 208 is serialized in a binary form to generate a waveform composed of 0 and 1. By repeating this process for n pieces of input data, n waveforms may be collected from P 202, U 204, and N 206. The waveform refers to the collected data set 210. After collecting the waveform, the similarity between each point forming the x-axis of UW and each point forming the X-axis of PW and NX may be measured.

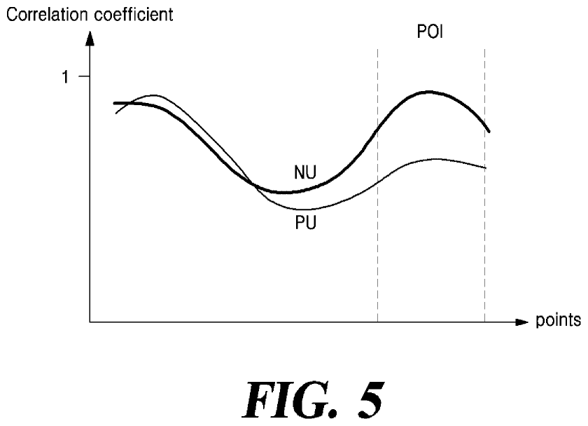

FIG. 5 is a diagram illustrating the similarity measurement results between PX, UX, and NX using a similarity measurement algorithm. Reference may be made to FIGS. 1 and 2 to illustrate FIG. 5.

FIG. 5 shows the similarity measurement results between PX, UX, and NX using the Pearson correlation coefficient. When a correlation graph between PW and UW is PU and a correlation graph between NW and UW is NU, NU shows a higher correlation graph than PU at a point of interest (POI) that is an analysis target section. That is, NU is closer to a correlation coefficient of 1 of the y-axis of the graph than PU at the POI. Thus, there may a high probability that U has not been patched. The POI refers to a point where the width of difference between the respective graphs is large. Referring to FIG. 5, the correlation coefficient of 1 of the y-axis of the graph is a preset threshold. The threshold may be different depending on an algorithm selected by a user. If UX is more similar to NX than PX, it is determined that there is a high probability that a vulnerability exists. That is, if NX is highly similar to UX, it is determined that the corresponding open source is not used for U. Conversely, if PX is highly similar to UX, it is determined that the corresponding open source is used for U.

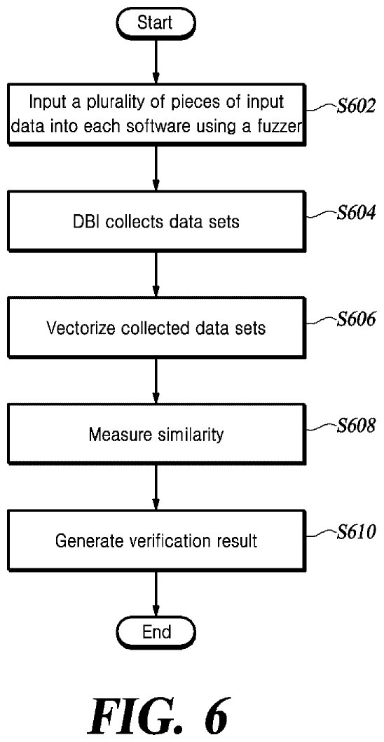

FIG. 6 is a flowchart of a process of verifying existence of particular open source, according to an embodiment of the present disclosure. Reference may be made to FIGS. 1 and 2 to illustrate the process of FIG. 6.

The fuzzer 100 generates random input data to the target software and supplies the input data to the software modules 202, 204, and 206. That is, a plurality of pieces of input data are input to each software module by using the fuzzer 100 (S602).

The first software module 202, the second software module 204 and the third software module 206 receive various input data from the fuzzer 100.

The first software module 202 is any software which uses particular open source to be verified. That is, as a patched module, the first software module 202 is defined as “P”.

The second software module 204 is target software for verifying whether a particular version of open source software is used. That is, an unknown module, the second software module 204 is defined as “U”.

The third software module 206 is any software which does not use a particular version of open source software to be verified. That is, as a non-patched module, the third software module 206 is defined as “N”.

The software modules 202, 204, 206 and the DBI environment 208 may be executed simultaneously. The DBI environment 208 collects data sets generated during a process in which the software modules 202, 204, and 206 process the input data (S604). In other words, the DBI environment 208 collects the data set 210 for various input data. The data set 210 includes a first data set 212, a second data set 214, and a third data set 216. The first data set 212 corresponds to PI, PR, and PW. PI is an instruction code set for P, PR is a memory read set for P, and PW is a memory write set for P. The second data set 214 corresponds to UI, UR, and UW. UI is an instruction code set for U, UR is a memory read set for U, and UW is a memory write set for U. The third data set 216 corresponds to NI, NR, NW. NI is an instruction code set for N, NR is a memory read set for N, and NW is a memory write set for N. X is a wildcard character to indicate any one of I, R, W.

The data sets collected from PX, UX, and NX are each converted into a two-dimensional matrix. In other words, the analyzer 200 vectorizes the data set 210 collected by the DBI environment 208. As the number of input data from the fuzzer 100 is the same, the number of rows is the same. As the patterns of instructions, writing, and reading performed according to each input data are different, the number of bytes of the column constituting each set may be different. To make the size of the two-dimensional matrices the same, padding may be performed based on the set having the longest column (S606).

A process of measuring similarity between data sets vectorized into two-dimensional matrices is as follows: measuring a first similarity between the first data set 212 for the first software module 202 and the second data set 214 for the second software module 204; and measuring a second similarity between the second data set 214 for the second software mode 204 and the third data set 216 for the third software module 206 (S608). In other words, the data set 210 collected by the DBI environment 208 is converted into a two-dimensional matrix, and then an algorithm selected by the user is used to measure whether the similarity between PX and UX is high and whether the similarity between NX and UX is low.

A process of generating a verification result based on the measured similarity is as follows: if the first similarity measured by using the algorithm selected by the user, for example, the Pearson correlation coefficient, is higher than the preset threshold, determining that the open source is used for the second software module; if the second similarity is higher than the preset threshold, determining that the open source is not used for the second software module, wherein the preset threshold may be different according to an algorithm selected by the user; if the first similarity is greater than the second similarity, determining that the open source is used for the second software module; and if the first similarity is less than the second similarity, determining that the open source is not used for the second hardware module (S610).

For example, if the similarity between PX and UX is high, it is determined that the open source is used for the second software module 204. That is, it is determined that the open source is used for U. Conversely, if the similarity between NX and UX is high, it is determined that the open source is not used for the second software module 204. That is, it is determined that the open source is not used for U.

As a result of measuring the similarity, when the similarity between UX and NX is higher than that between UX and PX, the analyzer 200 determines that there is a high probability that the vulnerability of the open source exists and generates a verification result. Therefore, the analyzer 200 generates the verification result based on the similarity measurement result.

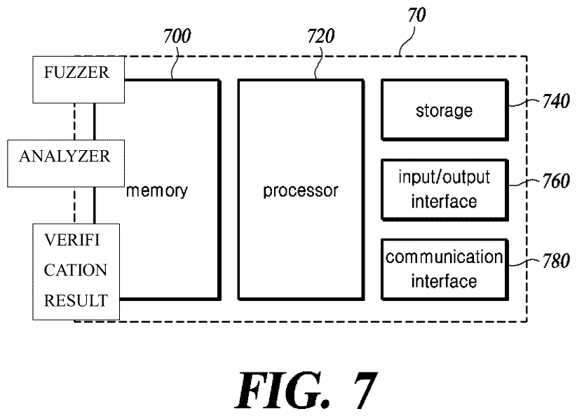

FIG. 7 is a schematic block diagram of a computing device which can be used to implement the computer-implemented method or the apparatus according to the present disclosure.

The computing device 70 may include all or part of a memory 700, a processor 720, a storage 740, an input/output interface 760, and a communication interface 780. The computing device 70 may be a stationary computing device, such as a desktop computer or a server, or a mobile computing device, such as a laptop computer or a smart phone. The computing device 70 may include a specialized hardware accelerator capable of processing operations of an artificial intelligence model in an efficient manner. For example, the computing device 70 may include a graphic processing unit (GPU), a tensor processing unit (TPU), or a neural processing unit (NPU).

The memory 700 may store a program that enables the processor 720 to perform methods or operations according to various embodiments of the present disclosure. For example, a program may include a plurality of instructions executable by the processor 720, and the methods or operations described above may be performed by executing the plurality of instructions by the processor 720. The memory 700 may consist of a single memory or a plurality of memories. In this case, information required to perform the methods or operation according to various embodiments of the present disclosure may be stored in a single memory or distributed across a plurality of memories. When the memory 700 is composed of a plurality of memories, the plurality of memories may be physically separated. The memory 700 may include at least one of volatile memory and non-volatile memory. Volatile memory includes Static Random Access Memory (SRAM) or Dynamic Random Access Memory (DRAM), while non-volatile memory includes flash memory.

The processor 720 may include at least one core capable of executing at least one instruction. The processor 720 may execute instructions stored in the memory 700. The processor 720 may consist of a single processor or a plurality of processors.

The storage 740 maintains stored data even if power supplied to the computing device 70 is cut off. For example, the storage 740 may include non-volatile memory or may include a storage medium such as a magnetic tape, an optical disk, or a magnetic disk. A program stored in the storage 740 may be loaded into the memory 700 before being executed by the processor 720. The storage 740 may store files written in a program language, and a program created from the files by a compiler may be loaded into the memory 700. The storage 740 may store data to be processed by the processor 720 and/or data processed by the processor 720.

The input/output interface 760 may provide an interface with an input device such as a keyboard or a mouse and/or an output device such as a display device or a printer. The user may trigger execution of a program by the processor 720 through the input device and/or check the processing results of the processor 720 through the output device.

The communication interface 780 may provide access to an external network. The computing device 70 may communicate with other devices through the communication interface 780.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Accordingly, one of ordinary skill would understand that the scope of the claimed invention is not to be limited by the above explicitly described embodiments but by the claims and equivalents thereof.

What is claimed is:

1. A computer-implemented method for verifying use of open source software, the computer-implemented method comprising:
inputting input data from a fuzzer into one or more software modules;
collecting, by the one or more software modules, data sets generated during a process of processing the input data;
vectorizing the collected data sets;
measuring a similarity between the vectorized data sets; and
generating a verification result based on the similarity.

2. The computer-implemented method of claim 1,
wherein the one or more software modules comprise a first software module,
a second software module, and a third software module.

3. The computer-implemented method of claim 2,
wherein the first software module is any software which uses open source to be verified, the second software module is target software for verifying whether the open source is used, and the third software module is any software which does not use the open source to be verified.

4. The computer-implemented method of claim 1,
wherein the generated data sets comprises a first data set, a second data set, and a third data set.

5. The computer-implemented method of claim 1, wherein the vectorizing of the collected data sets comprises arranging a plurality of pieces of data for a plurality of inputs according to a same bit length and converting the data into a two-dimensional matrix.

6. The computer-implemented method of claim 1, wherein the measuring of the similarity is implemented by an algorithm selected by a user.

7. The computer-implemented method of claim 6, wherein the algorithm comprises a Pearson correlation coefficient, a normalized compression distance, or a pattern matching.

8. The computer-implemented method of claim 2, wherein the measuring of the similarity between the vectorized data sets comprises:
measuring a first similarity between a first data set for the first software module and a second data set for the second software module; and
measuring a second similarity between a second data set for the second software module and a third data set for the third software module.

9. The computer-implemented method of claim 8, wherein the generating of the verification result based on the similarity comprises:
if the first similarity is higher than a preset threshold, determining that the open source is used for the second software module; and
if the second similarity is higher than the threshold, determining that the open source is not used for the second software module.

10. The computer-implemented method of claim 8, wherein the generating of the verification result based on the similarity comprises:
if the first similarity is greater than the second similarity, determining that the open source is used for the second software module; and
if the first similarity is less than the second similarity, determining that the open source is not used for the second software module.

11. An apparatus, comprising:
at least one memory; and
at least one processor, wherein, the at least one processor executes instructions for:
inputting input data from a fuzzer into one or more software modules;
collecting, by the software modules, data sets generated during a process of processing the input data;
vectorizing the collected data sets; and
measuring a similarity between the vectorized data sets; and
generating a verification result based on the similarity.

12. The apparatus of claim 11, wherein the one or more software modules comprise a first software module, a second software module, and a third software module.

13. The apparatus of claim 12, wherein the first software module is any software which uses open source to be verified,
the second software module is target software for verifying whether the open source is used, and
the third software module is any software which uses the open source to be verified.

14. The apparatus of claim 11, wherein the generated data sets comprise a first data set, a second data set, and a third data set.

15. The apparatus of claim 11, wherein the vectorizing of the collected data sets comprises arranging a plurality of pieces of data for a plurality of inputs according to the same bit length and converting the data into a two-dimensional matrix.

16. The apparatus of claim 11, wherein the measuring of the similarity is implemented by an algorithm selected by a user.

17. The apparatus of claim 16, wherein the algorithm comprises a Pearson correlation coefficient, a normalized compression distance, or a pattern matching.

18. The apparatus of claim 12, wherein the measuring of the similarity between the vectorized data sets comprises:
measuring a first similarity between a first data set for the first software module and a second data set for the second software module;
measuring a second similarity between a second data set for the second software module and a third data set for the third software module.

19. The apparatus of claim 18, wherein the generating of the verification result based on the similarity comprises:
if the first similarity is higher than a preset threshold, determining that the open source is used for the second software module; and
if the second similarity is higher than the threshold, determining that the open source is not used for the second software module.

20. The apparatus of claim 18, wherein the generating of the verification result based on the similarity comprises:
if the first similarity is greater than the second similarity, determining that the open source is used for the second software module; and
if the first similarity is less than the second similarity, determining that the open source is not used for the second software module.
